(19) United States
(12) Patent Application Publication
(10) Pub. No.: US 2023/0290173 A1
(43) Pub. Date: Sep. 14, 2023

(54) CIRCUITRY AND METHOD

(71) Applicant: Sony Group Corporation, Tokyo (JP)

(72) Inventor: Justinas MISEIKIS, Stuttgart (DE)

(73) Assignee: Sony Group Corporation, Tokyo (JP)

(21) Appl. No.: 18/116,379

(22) Filed: Mar. 2, 2023

(30) Foreign Application Priority Data
Mar. 9, 2022 (EP) 22160966.2

(51) Int. Cl. G06V 40/10; G06V 40/20; G06V 10/46; G06T 7/292

(52) U.S. Cl. CPC G06V 40/103; G06V 40/25; G06V 10/46; G06T 7/292; G06V 2201/07; G06T 2207/20084

(57) ABSTRACT

The present disclosure pertains to a circuitry for event-based tracking configured to recognize a person based on event-based visual data from a first dynamic vision sensor camera and from a second dynamic vision sensor camera, and track the person based on a movement of the person when the person leaves a first field-of-view of the first dynamic vision sensor camera and enters a second field-of-view of the second dynamic vision sensor camera.

### CROSS-REFERENCE TO RELATED APPLICATION

The present application claims priority to European Patent Application No. 22160966.2, filed Mar. 9, 2022, the entire contents of which are incorporated herein by reference.

### TECHNICAL FIELD

The present disclosure generally pertains to a circuitry and a method and, in particular, to a circuitry for event-based tracking and a method for event-based tracking.

### TECHNICAL BACKGROUND

Autonomous stores such as Amazon Go and Standard Cognition are known. Such autonomous stores are able to track people and their actions through the autonomous store based on images acquired by cameras. At entering an autonomous store, a user identifies himself, for example with his smartphone, membership card or credit card. For purchasing an item from the autonomous store, the user can simply pick the item and leave the autonomous store without registering the item at a checkout. Based on tracking the user and his actions in the autonomous store, the picking of the item by the user is automatically detected and an account associated with the user is automatically charged with the price of the picked item.

Furthermore, dynamic-vision sensor (DVS) cameras are known. DVS cameras do provide not the full visual information included in an image, but only changes in the scene. This means that there is no full visual frame captured. Instead of frames, DVS cameras detect asynchronous events (changes in single pixels).

Although there exist techniques for tracking, it is generally desirable to provide an improved circuitry and method for event-based tracking.

### SUMMARY

According to a first aspect, the disclosure provides a circuitry for event-based tracking, configured to recognize a person based on event-based visual data from a first dynamic vision sensor camera and from a second dynamic vision sensor camera; and track the person based on a movement of the person when the person leaves a first field-of-view of the first dynamic vision sensor camera and enters a second field-of-view of the second dynamic vision sensor camera.

According to a second aspect, the disclosure provides a method for event-based tracking, comprising recognizing a person based on event-based visual data from a first dynamic vision sensor camera and from a second dynamic vision sensor camera; and tracking the person based on a movement of the person when the person leaves a first field-of-view of the first dynamic vision sensor camera and enters a second field-of-view of the second dynamic vision sensor camera.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 illustrates a block diagram of an autonomous store with a circuitry according to an embodiment;

FIG. 2 illustrates a block diagram of a circuitry according to an embodiment; and

FIG. 3 illustrates a block diagram of a method according to an embodiment.

### DETAILED DESCRIPTION OF EMBODIMENTS

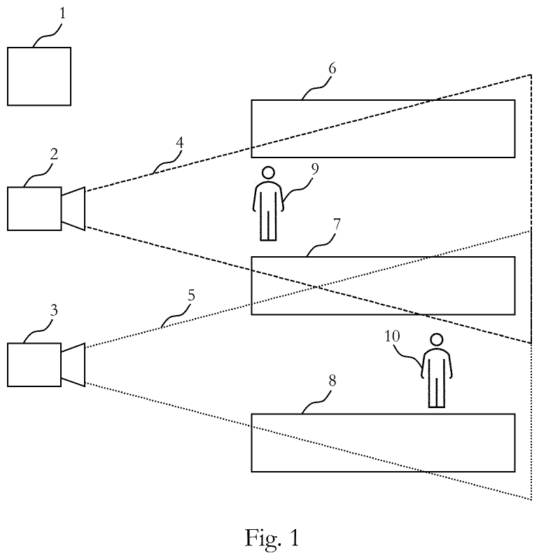

Before a detailed description of the embodiments under reference of FIG. 1 is provided, general explanations are made.

As discussed in the outset, autonomous stores such as Amazon Go and Standard Cognition are known. Such autonomous stores are able to track people and their actions through the autonomous store based on images acquired by cameras. At entering an autonomous store, a user identifies himself, for example with his smartphone, membership card or credit card. For purchasing an item from the autonomous store, the user can simply pick the item and leave the autonomous store without registering the item at a checkout. Based on tracking the user and his actions in the autonomous store, the picking of the item by the user is automatically detected and an account associated with the user is automatically charged with the price of the picked item.

However, in some instances, autonomous stores are very privacy invasive, for example, because the images acquired for tracking a person may allow identifying the person. Therefore, expansion of autonomous stores in Europe, where the General Data Protection Regulation (GDPR) requires high data protection standards, or in other legislations with similar regulations for data protection, might be limited by likely breaches of rules required by the corresponding data protection regulations. Moreover, in some instances, some people may be hesitant to visit autonomous stores in order to protect their privacy.

Furthermore, dynamic-vision sensor (DVS) cameras are known. DVS cameras do provide not the full visual information included in an image, but only changes in the scene. This means that there is no full visual frame captured and no information about the identity of the person. Instead of frames, DVS cameras detect asynchronous events (changes in single pixels).

Thus, in some embodiments, people can be tracked with a DVS camera anonymously as moving objects in a scene (e.g. in an autonomous store), but still with capability of clear distinction between a person and other objects. Another benefit of tracking people in a scene with a DVS camera is, in some embodiments, that good lighting conditions are not necessary in the whole scene (e.g., autonomous store) for tracking with DVS cameras, as DVS cameras may perform significantly better compared to standard frame cameras that provide images of full frames. Given the ability to use standard lenses of various field-of-view, it may be possible to cover a large store area with multiple DVS cameras and track objects in-between fields-of-view of the different DVS cameras by re-identifying the people based on movements alone.

Privacy-aware person tracking is performed, in some embodiments, for retail analytics or for an autonomous store.

Currently, in some embodiments, DVS cameras are significantly more expensive compared to standard frame cameras, however, with mass adoption and production, the price of DVS cameras is expected to drop significantly, possibly to the level of standard color frame cameras.

In some embodiments, a whole system consists of an arbitrary number of DVS cameras strategically placed in an autonomous store, possibly on a ceiling to provide a good overview of the whole floor plan. Depending on the needs of the detection, either the whole autonomous store may be observed by the DVS cameras, or only areas of interest, such as passageways, specific aisles and sections.

In some embodiments, people detection and tracking are trained using Artificial Neural Networks (ANNs). Provided an external calibration of the DVS cameras, a spatial relationship between the DVS cameras may be known. This may allow to keep track of a person exiting a field-of-view of one DVS camera and entering a field-of-view of another DVS camera.

Consequently, some embodiments of the present disclosure pertain to a circuitry for event-based tracking configured to recognize a person based on event-based visual data from a first dynamic vision sensor camera and from a second dynamic vision sensor camera; and track the person based on a movement of the person when the person leaves a first field-of-view of the first dynamic vision sensor camera and enters a second field-of-view of the second dynamic vision sensor camera.

The circuitry may include any entity capable of processing event-based visual data. For example, the circuitry may include a semiconductor device. The circuitry may include an integrated circuit, for example a microprocessor, a reduced instruction set computer (RISC), a complex instruction set computer (CISC), a field-programmable gate array (FPGA), an application-specific integrated circuit (ASIC), a central processing unit (CPU), a graphics processing unit (GPU) and/or a tensor processing unit (TPU).

The event-based tracking may be based on event-based visual data acquired by dynamic vision sensor (DVS) cameras such as the first DVS camera and the second DVS camera. The DVS cameras may detect asynchronous changes of light incident in single pixels and may generate, as the event-based visual data, data indicating a time of the corresponding change and a position of the corresponding pixel. For example, DVS cameras such as the first DVS camera and the second DVS camera may be configured to capture up to 1,000,000 events per second, without limiting the present disclosure to this value.

DVS cameras such as the first DVS camera and the second DVS camera may include an event camera, a neuromorphic camera, and/or a silicon retina.

The first DVS camera and the second DVS camera may transmit the acquired event-based visual data to the circuitry via a wired and/or a wireless connection.

The first DVS camera may acquire event-based visual data related to a first field-of-view, and the second DVS camera may acquire event-based visual data related to a second field-of-view. The first field-of-view and the second field-of-view may overlap or may not overlap. A position and orientation of the first DVS camera and a position and orientation of the second DVS camera in a scene may be predetermined. Likewise, positions and orientations of the first and second field-of-view in the scene may be predetermined, and portions of the scene covered by the respective fields-of-view may be predetermined.

The event-based tracking may include determining positions of a person while the person moves within the scene, for example in an autonomous store. The circuitry may obtain event-based visual data from dynamic vision sensor (DVS) cameras such as the first DVS camera and the second DVS camera. The event-based tracking may be based on the events indicated by the event-based visual data obtained from the DVS cameras.

The event-based tracking may include the tracking of the person based on a movement of the person when the person leaves the first field-of-view and enters the second field-of-view. The positions and orientations of the first and second fields-of-view may be predetermined and known, such that it may be possible to keep track of the person across fields-of-view. For example, when the person leaves the first field-of-view in a direction of the second field-of-view and enters the second field-of-view from a direction of the first field-of-view, the circuitry may recognize the person entering the second field-of-view as being the same person leaving the first field-of-view, based on a correlation of the movements of the person detected in the first and second field-of-view. The tracking may be performed in an embodiment where the first field-of-view and the second field-of-view overlap such that a time interval in which the first DVS camera acquires events indicating a movement of the person and a time interval in which the second DVS camera acquires events indicating a movement of the person overlap. The tracking may also be performed in an embodiment where the first field-of-view and the second field-of-view do not overlap such that a time interval in which the first DVS camera acquires events indicating a movement of the person and a time interval in which the second DVS camera acquires events indicating a movement of the person do not overlap.

The solution according to the present disclosure provides, in some embodiments, benefits over using standard (color) frame cameras.

For example, the benefits may include fast tracking. An event may correspond to a much shorter time interval than an exposure time for acquiring an image frame with a standard frame camera. Therefore, event-based tracking may not have to cope with effects of motion blur, such that less elaborate and less time-consuming image processing may be necessary.

For example, the benefits may include a privacy aware system. An identity of tracked people may not be known to the system because no full image frame of a person may be acquired but only single events. Even in case of data breach, it may not be possible to reconstruct an image of a person based only on the event-based visual data. Therefore, event-based tracking according to the present disclosure may be less privacy invasive than tracking based on full image frames.

For example, the benefits may include reliable detection under difficult illumination conditions. For example, DVS cameras such as the first DVS camera and the second DVS camera may be more robust to over and under exposed areas than a standard frame camera. Hence, event-based tracking according to the present disclosure may be more robust with respect to illumination of the scene (e.g., autonomous store) than tracking based on images acquired by standard frame cameras.

In some embodiments, the tracking includes determining a motion vector of the person in the first field-of-view and a motion vector of the person in the second field-of-view based on positions of the first field-of-view and of the second field-of-view in a scene; and tracking the person based on a movement indicated by the motion vectors.

For example, the motion vectors of the person may be determined based on a chronological order of events included in the event-based visual data and on a mapping between pixels of the respective DVS camera and corresponding positions in the scene.

For example, the motion vector of the person in the first field-of-view may be determined to point in direction of the second field-of-view, and the motion vector of the person in the second field-of-view may be determined to point in a direction opposite to a direction of the first field-of-view. The tracking may include detecting a correlation between the motion vectors of the person in the first and second field-of-view, respectively. For example, the motion vectors of the person in the first and second field-of-view may be regarded as correlated if their directions, with respect to the scene, differ by less than a predetermined threshold. If the motion vectors are correlated, they may indicate a same movement of the person, and the circuitry may determine that the person exhibiting the movement in the first field-of-view is the same person as the person exhibiting the correlated movement in the second field-of-view.

In some embodiments, the tracking includes generating, based on the event-based visual data, identification information of the person; detecting a collision of the person with another person based on the event-based visual data; and re-identifying the person after the collision based on the identification information.

The identification information of the person may be information that allows to recognize (identify) the person among other persons. The identification information of the person may indicate characteristics of the person that can be derived from the event-based visual data. The circuitry may generate the identification information before the collision, e.g., as soon as the circuitry detects the person.

A collision of the person with another person may include a situation where the person and the other person come into physical contact. The collision of the person with the other person may also include a situation where the person and the other person do not come into physical contact, but where projections of the person and of the other person on a DVS camera (such as the first or the second DVS camera) overlap such that the person and the other person appear as one contiguous object in the event-based visual data.

After the collision (i.e., when the person and the other person appear again as separate objects in the event-based visual data), the circuitry may re-identify the person based on the identification information (and may re-identify the other person based on identification information of the other person). The re-identification of the person may or may not be further based on a position and/or a movement direction of the person in the scene that have been detected before the collision.

In some embodiments, the identification information includes at least one of an individual movement pattern of the person, a body size of the person and an outline of the person.

Thus, the identification information may allow identifying the person based on the event-based visual data.

In some embodiments, the recognizing of the person includes detecting a moving object based on the event-based visual data; and identifying the detected moving object as a person based on at least one of an outline and a movement pattern.

For example, upon detecting a moving object, the circuitry may check the detected moving object for predetermined outline features and/or for predetermined movement patterns that are typical for an outline of a human body or for human movements, respectively.

In some embodiments, at least one of the recognizing of the person and the tracking of the person is performed based on using an artificial neural network.

The artificial neural network may, for example, include a convolutional neural network or a recurrent neural network. The artificial neural network may be trained to recognize a person based on event-based visual data, generate identification information of the person based on the event-based visual data, track the person based on the event-based visual data when it moves within a field-of-view of a DVS camera or across fields-of-view of several DVS cameras (such as the first DVS camera and the second DVS camera), and/or re-identify the person based on the identification information after a collision with another person, as described above.

In some embodiments, the circuitry is further configured to determine, based on a result of the tracking of the person, a region in which the person is not present; and mark the region for allowing an automatic operation in the region.

For example, in an autonomous store, the circuitry may determine, based on a result of tracking of persons in the autonomous store, that no person is present in an area of interest, such as a passageway, an aisle or a section of the autonomous store. For example, the circuitry may determine that no person is present in the area of interest when no events (or a low number of events as compared to an area in which a person is present) are captured from the area of interest. The marking of the region for allowing the automatic operation in the region may include generating a corresponding entry in a database.

For example, the automatic operation may be performed by a robot. The automatic operation may include an operation that could fail if a person interferes with the automatic operation or in which a present person could be hurt.

In some embodiments, the automatic operation includes at least one of restocking, disinfecting and cleaning.

For example, in an autonomous store, the restocking may include putting goods for sale in a goods shelf, and the disinfecting or the cleaning may include disinfecting or cleaning, respectively, a passageway, an aisle, a section, a shelf or the like of the autonomous store.

In some embodiments, the circuitry is further configured to determine, based on the event-based visual data, an object picked by the person.

For example, in an autonomous store, the circuitry may detect that the person has picked an object for sale from a goods shelf, and may determine which object the person has picked based on the event-based visual data.

In some embodiments, the determining of the picked object is based on a shape of the object detected based on the event-based visual data.

For example, the shape (including the size) of the object may be characteristic for the object such that the object can be identified based on the detected shape.

In some embodiments, the determining of the picked object is based on sensor fusion for detecting a removal of the object.

For example, the circuitry may detect that the object is removed from a goods shelf and/or may identify the object removed from the goods shelf based, in addition to the event-based visual data, on data from another sensor, e.g., from a weight sensor (scale) in the goods shelf and/or from a photoelectric sensor in the goods shelf.

Some embodiments pertain to a method for event-based tracking that includes recognizing a person based on event-based visual data from a first dynamic vision sensor camera and from a second dynamic vision sensor camera; and tracking the person based on a movement of the person when the person leaves a first field-of-view of the first dynamic vision sensor camera and enters a second field-of-view of the second dynamic vision sensor camera.

The method may be configured corresponding to the circuitry described above, and all features of the circuitry may be corresponding features of the method. For example, the circuitry may be configured to perform the method.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, FIG. 1 illustrates a block diagram of an autonomous store with a circuitry 1 according to an embodiment.

The circuitry 1 receives event-based visual data from a first DVS camera 2 and a second DVS camera 3. The first DVS camera 2 acquires event-based visual data that correspond to changes in a first field-of-view 4, and the second DVS camera 3 acquires event-based visual data that correspond to changes in a second field-of-view 5.

The autonomous store includes a first goods shelf 6, a second goods shelf 7 and a third goods shelf 8. The first DVS camera 2 and the second DVS camera 3 are arranged at a ceiling of the autonomous store such that the first field-of-view 4 of the first DVS camera 2 covers an aisle between the first goods shelf 6 and the second goods shelf 7, and that the second field-of-view 5 of the second DVS camera 3 covers an aisle between the second goods shelf 7 and the third goods shelf 8.

A person 9 is in the aisle between the first goods shelf 6 and the second goods shelf 7. The circuitry 1 tracks the position of the person 9 based on the event-based visual data from the first DVS camera 2 and the second DVS camera 3. I.e., as long as the person 9 remains in the first field-of-view 4 of the first DVS camera 2, the circuitry 1 tracks the person 9 based on the event-based visual data of the first DVS camera 2. If the person 9 leaves the first field-of-view 4 and enters the second field-of-view 5, the circuitry 1 tracks the person 9 across the first and second field-of-view 4 and 5.

The circuitry 1 generates identification information of the person 9 based on the event-based visual data that includes an individual movement pattern of the person 9, a body size of the person 9 and an outline of the person 9. If the person 9 moves into the aisle between the second goods shelf 7 and the third goods shelf 8 and approaches another person 10 such that the person 9 and the other person 10 appear as one contiguous object in the event-based visual data and cannot be separated based on the event-based visual data, the circuitry 1 re-identifies the person 9 based on the generated identification information when the person 9 leaves the other person 10 such that the person 9 and the other person 10 can be distinguished again based on the event-based visual data (i.e., the person 9 and the other person 10 appear as separate objects in the event-based visual data).

Further, when the person 9 leaves the aisle between the first goods shelf 6 and the second goods shelf 7 such that nobody remains in the aisle between the first goods shelf 6 and the second goods shelf 7, the circuitry 1 determines based on a result of tracking the person 9 that the person 9 is not present (and no other person is present, either) in the aisle between the first goods shelf 6 and the second goods shelf 7 and marks the aisle between the first goods shelf 6 and the second goods shelf 7 in a database for allowing an automatic operation such as restocking, disinfecting and cleaning to be performed in the aisle between the first goods shelf 6 and the second goods shelf 7. When a person enters the aisle between the first goods shelf 6 and the second goods shelf 7, the circuitry 1 unmarks the aisle between the first goods shelf 6 and the second goods shelf 7 for not allowing the automatic operation anymore.

When the person 9 picks an object from any one of the goods shelfs 6, 7 or 8, the circuitry 1 determines, based on the event-based visual data, that the person 9 has picked an object and which object the person 9 has picked. The circuitry 1 recognizes the picked object based on a shape of the object.

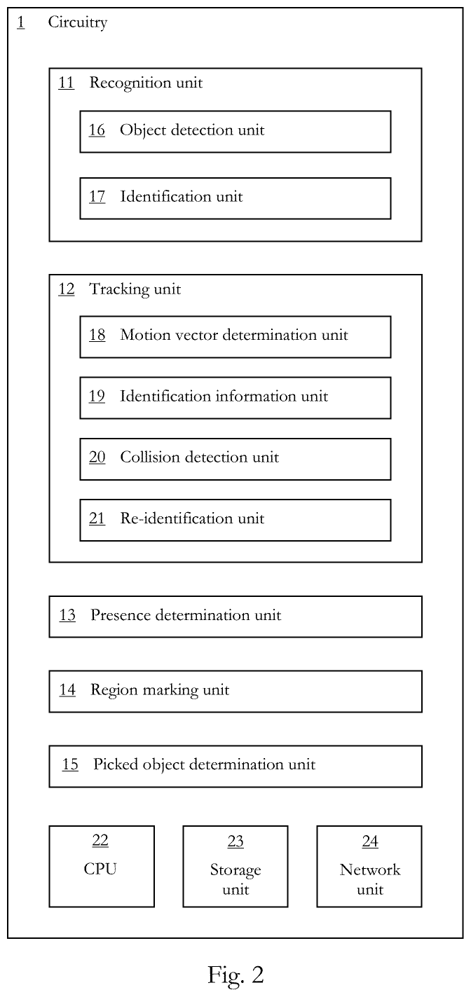

FIG. 2 illustrates a block diagram of the circuitry 1 according to an embodiment. The circuitry 1 is an example of the circuitry 1 of FIG. 1. The circuitry 1 includes a recognition unit 11, a tracking unit 12, a presence determination unit 13, a region marking unit 14 and a picked object determination unit 15.

The circuitry 1 receives event-based visual data from a first DVS camera (e.g., the first DVS camera 2 of FIG. 1) and from a second DVS camera (e.g., the second DVS camera 3 of FIG. 1).

The recognition unit 11 recognizes a person (e.g., person 9 of FIG. 1) based on the event-based visual data from the first DVS camera 2 and from the second DVS camera 3.

The recognition unit 11 includes an object detection unit 16 and an identification unit 17.

The object detection unit 16 detects, based on the event-based visual data from the first DVS camera 2 and from the second DVS camera 3, a moving object in at least one of the first and second fields-of-view 4 and 5. The object detection unit 16 provides the result of detecting the moving object to the identification unit 17.

The identification unit 17 identifies the detected moving object as a person 9 based on an outline and a movement pattern of the detected moving object. I.e., the identification unit 17 checks whether the outline of the detected moving object exhibits typical features of an outline of a human body and whether the movement pattern of the detected moving object exhibits typical features of a movement pattern of a human body. If the identification unit 17 determines that the outline and movement pattern of the detected moving object exhibit typical features of an outline and movement pattern, respectively, of a human body, the identification unit 17 identifies the detected moving object as a person 9.

The tracking unit 12 tracks the person 9 based on a movement of the person 9 when the person leaves a first field-of-view (e.g., the first field-of-view 4 of FIG. 1) and enters a second field-of-view (e.g., the second field-of-view 5 of FIG. 1). The tracking unit 12 receives information about the detected moving object identified, by the identification unit 17, as a person 9, and determines a movement of the person 9.

The tracking unit 12 includes a motion vector determination unit 18, an identification information unit 19, a collision detection unit 20 and a re-identification unit 21.

The motion vector determination unit 18 determines a motion vector of the person 9 in the first field-of-view 4 and a motion vector of the person 9 in the second field-of-view 5 based on positions of the first field-of-view 4 and of the second field-of-view 5 in the scene (i.e., in the autonomous store). The positions of the first field-of-view 4 and of the second field-of-view 5 are predetermined.

The tracking unit 12 receives information indicating the motion vectors of the person 9 in the first field-of-view 4 and in the second field-of-view 5 determined by the motion vector determination unit 18. The tracking unit 12 then determines a movement of the person 9 indicated by the motion vectors of the person 9 in the first field-of-view 4 and in the second field-of-view 5, and tracks the person 9 based on the movement indicated by the motion vectors.

The identification information unit 19 generates, based on the event-based visual data, identification information of the person 9. When the recognition unit 11 recognizes the person 9, the identification information unit 19 extracts, from the event-based visual data, information that allows to identify the person 9, including an individual movement pattern of the person 9, a body size of the person 9 and an outline of the person 9, and includes such information in the generated identification information.

The collision detection unit 20 detects a collision of the person 9 with another person (e.g., the other person 10 of FIG. 1) based on the event-based visual data, i.e., the collision detection unit 20 detects that the person 9 and the other person 10 cannot be distinguished anymore based on the event-based visual data but appear as one contiguous object. The collision detection unit 20 also detects an end of the collision, i.e., when the person 9 and the other person 10 can be distinguished again based on the event-based visual data and appear as separate objects.

The re-identification unit 21 receives the identification information generated by the identification information unit 19. When the collision detection unit 20 detects an end of the collision of the person 9 and the other person 10, the re-identification unit 21 re-identifies the person 9 based on the identification information, i.e., the re-identification unit 21 determines which one of the persons detected after the collision is the person 9 by comparing characteristics of the persons detected after the collision with the identification information.

The recognition unit 11 and the tracking unit 12 include an artificial neural network that is trained to recognize and track the person 9, respectively. The artificial neural network provides functionality of the recognition unit 11 with the object detection unit 16 and the identification unit 17 and of the tracking unit 12 with the motion vector determination unit 18, the identification information unit 19, the collision detection unit 20 and the re-identification unit 21.

The circuitry 1 includes a presence determination unit 13 and a region marking unit 14. The presence determination unit 13 determines, based on a result of the tracking performed by the tracking unit 12, a region in the autonomous store in which the person 9 is not present. The region marking unit 14 marks the region determined by the presence determination unit 13 in which the person 9 is not present for allowing, in the region, an automatic operation including restocking, disinfecting and cleaning.

The circuitry 1 includes a picked object determination unit 15. The picked object determination unit 15 determines, based on the event-based visual data, an object picked by the person 9 from a goods shelf (e.g., any one of the first goods shelf 6, the second goods shelf 7 and the third goods shelf 8 of FIG. 1). The picked object determination unit 15 detects, based on the event-based visual data, a shape of the picked object and determines the picked object based on the detected shape of the picked object. The picked object determination unit 15 receives weight data from a weight sensor (scale) in the goods shelf 6, 7 or 8 and detects a removal of the object from the goods shelf 6, 7 or 8 based on sensor fusion, i.e., based on both the event-based visual data and the weight data.

The circuitry 1 further includes a central processing unit (CPU) 22, storage unit 23 and a network unit 24.

The CPU 22 executes an operating system and performs general controlling of the circuitry 1. The storage unit 23 stores software to be executed by the CPU 22 as well as data (including configuration data, permanent data and temporary data) read or written by the CPU 22. The network unit 24 communicates via a network with other devices, e.g., for receiving the event-based visual data, for transmitting a result of the tracking performed by the tracking unit 12, for the marking and unmarking performed by the region marking unit 14 and for transmitting a result of the determination of a picked object performed by the picked object determination unit 15.

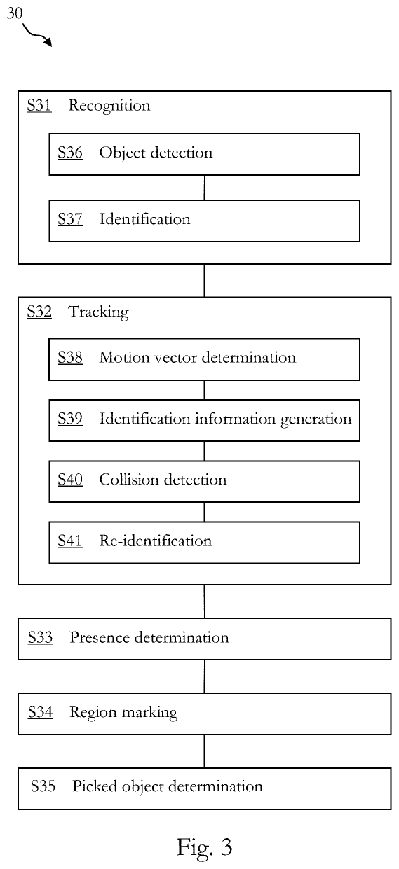

FIG. 3 illustrates a block diagram of a method 30 according to an embodiment. The method 30 is performed by the circuitry 1 of FIGS. 1 and 2. The method 30 includes a recognition at S31, a tracking at S32, a presence determination at S33, a region marking at S34 and a picked object determination at S35.

The recognition at S31 is performed by the recognition unit 11 of FIG. 2. The recognition at S31 recognizes a person (e.g., person 9 of FIG. 1), based on event-based visual data from a first DVS camera (e.g., first DVS camera 2 of FIG. 1) and from a second DVS camera (e.g., second DVS camera 3 of FIG. 1).

The recognition at S31 includes an object detection at S36 and an identification at S37.

The object detection at S36 is performed by the object detection unit 16 of FIG. 2 and detects, based on the event-based visual data from the first DVS camera 2 and from the second DVS camera 3, a moving object in at least one of the first field-of-view 4 of the first DVS camera 2 and the second field-of-view 5 of the second DVS camera 3.

The identification at S37 is performed by the identification unit 17 of FIG. 2 and identifies the detected moving object as a person 9 based on an outline and a movement pattern of the detected moving object. I.e., the identification at S37 checks whether the outline of the detected moving object exhibits typical features of an outline of a human body and whether the movement pattern of the detected moving object exhibits typical features of a movement pattern of a human body. If the identification determines that the outline and movement pattern of the detected moving object exhibit typical features of an outline and movement pattern, respectively, of a human body, the identification identifies the detected moving object as a person 9.

The tracking at S32 is performed by the tracking unit 12 of FIG. 2 and tracks the person 9 based on a movement of the person 9 when the person leaves a first field-of-view (e.g., the first field-of-view 4 of FIG. 1) and enters a second field-of-view (e.g., the second field-of-view 5 of FIG. 1). The tracking at S32 receives information about the detected moving object identified, by the identification at S37, as a person 9, and determines a movement of the person 9.

The tracking at S32 includes a motion vector determination at S38, an identification information generation at S39, a collision detection at S40 and a re-identification at S41.

The motion vector determination at S38 is performed by the motion vector determination unit 18 of FIG. 2 and determines a motion vector of the person 9 in the first field-of-view 4 and a motion vector of the person 9 in the second field-of-view 5 based on positions of the first field-of-view 4 and of the second field-of-view 5 in the scene (i.e., in the autonomous store). The positions of the first field-of-view 4 and of the second field-of-view 5 are predetermined.

The tracking at S32 receives information indicating the motion vectors of the person 9 in the first field-of-view 4 and in the second field-of-view 5 determined by the motion vector determination at S38. The tracking at S32 then determines a movement of the person 9 indicated by the motion vectors of the person 9 in the first field-of-view 4 and in the second field-of-view 5, and tracks the person 9 based on the movement indicated by the motion vectors.

The identification information generation at S39 is performed by the identification information unit 19 of FIG. 2 and generates, based on the event-based visual data, identification information of the person 9. When the recognition at S31 recognizes the person 9, the identification information generation at S39 extracts, from the event-based visual data, information that allows to identify the person 9, including an individual movement pattern of the person 9, a body size of the person 9 and an outline of the person 9, and includes such information in the generated identification information.

The collision detection at S40 is performed by the collision detection unit 20 of FIG. 2 and detects a collision of the person 9 with another person (e.g., the other person 10 of FIG. 1) based on the event-based visual data, i.e., the collision detection at S40 detects that the person 9 and the other person 10 cannot be distinguished anymore based on the event-based visual data but appear as one contiguous object. The collision detection at S40 also detects an end of the collision, i.e., when the person 9 and the other person 10 can be distinguished again based on the event-based visual data and appear as separate objects.

The re-identification at S41 is performed by the re-identification unit 21 of FIG. 2 and receives the identification information generated by the identification information generation at S39. When the collision detection at S40 detects an end of the collision of the person 9 and the other person 10, the re-identification at S41 re-identifies the person 9 based on the identification information, i.e., the re-identification at S41 determines which one of the persons detected after the collision is the person 9 by comparing characteristics of the persons detected after the collision with the identification information.

The recognition at S31 and the tracking at S32 are performed based on using an artificial neural network that is trained to recognize and track the person 9, respectively. The artificial neural network provides functionality of the recognition at S31 with the object detection at S36 and the identification at S37 and of the tracking at S32 with the motion vector determination at S38, the identification information generation at S39, the collision detection at S40 and the re-identification at S41.

The method 30 includes a presence determination at S33 and a region marking at S34. The presence determination at S33 is performed by the presence determination unit 13 of FIG. 2 and determines, based on a result of the tracking performed by the tracking at S32, a region in the autonomous store in which the person 9 is not present. The region marking at S34 is performed by the region marking unit 14 of FIG. 2 and marks the region determined by the presence determination at S33 in which the person 9 is not present for allowing, in the region, an automatic operation including restocking, disinfecting and cleaning.

The method 30 includes a picked object determination at S35. The picked object determination at S35 is performed by the picked object determination unit 15 of FIG. 2 and determines, based on the event-based visual data, an object picked by the person 9 from a goods shelf (e.g., any one of the first goods shelf 6, the second goods shelf 7 and the third goods shelf 8 of FIG. 1). The picked object determination at S35 detects, based on the event-based visual data, a shape of the picked object and determines the picked object based on the detected shape of the picked object. The picked object determination at S35 receives weight data from a weight sensor (scale) in the goods shelf 6, 7 or 8 and detects a removal of the object from the goods shelf 6, 7 or 8 based on sensor fusion, i.e., based on both the event-based visual data and the weight data.

It should be recognized that the embodiments describe methods with an exemplary ordering of method steps. The specific ordering of method steps is however given for illustrative purposes only and should not be construed as binding. For example, the ordering of S38 and S39 in the embodiment of FIG. 3 may be exchanged. Also, S35 may be performed before S33 in the embodiment of FIG. 3. Other changes of the ordering of method steps may be apparent to the skilled person.

Please note that the division of the circuitry 1 into units 11 to 22 is only made for illustration purposes and that the present disclosure is not limited to any specific division of functions in specific units. For instance, the circuitry 1 could be implemented by a respective programmed processor, field programmable gate array (FPGA) and the like.

The method 30 in the embodiment of FIG. 3 can also be implemented as a computer program causing a computer and/or a processor, such as circuitry 1 and/or CPU 22 discussed above, to perform the method, when being carried out on the computer and/or processor. In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) A circuitry for event-based tracking, configured to:
   recognize a person based on event-based visual data from a first dynamic vision sensor camera and from a second dynamic vision sensor camera; and
   track the person based on a movement of the person when the person leaves a first field-of-view of the first dynamic vision sensor camera and enters a second field-of-view of the second dynamic vision sensor camera.
(2) The circuitry of (1), wherein the tracking includes:
   determining a motion vector of the person in the first field-of-view and a motion vector of the person in the second field-of-view based on positions of the first field-of-view and of the second field-of-view in a scene; and
   tracking the person based on a movement indicated by the motion vectors.
(3) The circuitry of (1) or (2), wherein the tracking includes:
   generating, based on the event-based visual data, identification information of the person;
   detecting a collision of the person with another person based on the event-based visual data; and
   re-identifying the person after the collision based on the identification information.
(4) The circuitry of (3), wherein the identification information includes at least one of an individual movement pattern of the person, a body size of the person and an outline of the person.
(5) The circuitry of any one of (1) to (4), wherein the recognizing of the person includes:
   detecting a moving object based on the event-based visual data; and
   identifying the detected moving object as a person based on at least one of an outline and a movement pattern.
(6) The circuitry of any one of (1) to (5), wherein at least one of the recognizing of the person and the tracking of the person is performed based on using an artificial neural network.
(7) The circuitry of any one of (1) to (6), wherein the circuitry is further configured to:
   determine, based on a result of the tracking of the person, a region in which the person is not present; and
   mark the region for allowing an automatic operation in the region.
(8) The circuitry of (7), wherein the automatic operation includes at least one of restocking, disinfecting and cleaning.
(9) The circuitry of any one of (1) to (8), wherein the circuitry is further configured to:
   determine, based on the event-based visual data, an object picked by the person.
(10) The circuitry of (9), wherein the determining of the picked object is based on a shape of the object detected based on the event-based visual data.
(11) The circuitry of (9) or (10), wherein the determining of the picked object is based on sensor fusion for detecting a removal of the object.
(12) A method for event-based tracking, comprising:
   recognizing a person based on event-based visual data from a first dynamic vision sensor camera and from a second dynamic vision sensor camera; and
   tracking the person based on a movement of the person when the person leaves a first field-of-view of the first dynamic vision sensor camera and enters a second field-of-view of the second dynamic vision sensor camera.
(13) The method of (12), wherein the tracking includes:
   determining a motion vector of the person in the first field-of-view and a motion vector of the person in the second field-of-view based on positions of the first field-of-view and of the second field-of-view in a scene; and
   tracking the person based on a movement indicated by the motion vectors.
(14) The method of (12) or (13), wherein the tracking includes:
   generating, based on the event-based visual data, identification information of the person;
   detecting a collision of the person with another person based on the event-based visual data; and
   re-identifying the person after the collision based on the identification information.
(15) The method of (14), wherein the identification information includes at least one of an individual movement pattern of the person, a body size of the person and an outline of the person.
(16) The method of any one of (12) to (15), wherein the recognizing of the person includes:
   detecting a moving object based on the event-based visual data; and
   identifying the detected moving object as a person based on at least one of an outline and a movement pattern.
(17) The method of any one of (12) to (16), wherein at least one of the recognizing of the person and the tracking of the person is performed based on using an artificial neural network.
(18) The method of any one of (12) to (17), further comprising:
   determining, based on a result of the tracking of the person, a region in which the person is not present; and
   marking the region for allowing an automatic operation in the region.
(19) The circuitry of (18), wherein the automatic operation includes at least one of restocking, disinfecting and cleaning.
(20) The method of any one of (12) to (19), further comprising:
   determining, based on the event-based visual data, an object picked by the person.
(21) The method of (20), wherein the determining of the picked object is based on a shape of the object detected based on the event-based visual data.
(22) The method of (20) or (21), wherein the determining of the picked object is based on sensor fusion for detecting a removal of the object.
(23) A computer program comprising program code causing a computer to perform the method according to anyone of (12) to (22), when being carried out on a computer.
(24) A non-transitory computer-readable recording medium that stores therein a computer program product, which, when executed by a processor, causes the method according to anyone of (12) to (22) to be performed.

1. A circuitry for event-based tracking, configured to:
recognize a person based on event-based visual data from a first dynamic vision sensor camera and from a second dynamic vision sensor camera; and
track the person based on a movement of the person when the person leaves a first field-of-view of the first dynamic vision sensor camera and enters a second field-of-view of the second dynamic vision sensor camera.

2. The circuitry of claim 1, wherein the tracking includes:
determining a motion vector of the person in the first field-of-view and a motion vector of the person in the second field-of-view based on positions of the first field-of-view and of the second field-of-view in a scene; and
tracking the person based on a movement indicated by the motion vectors.

3. The circuitry of claim 1, wherein the tracking includes:
generating, based on the event-based visual data, identification information of the person;
detecting a collision of the person with another person based on the event-based visual data; and
re-identifying the person after the collision based on the identification information.

4. The circuitry of claim 3, wherein the identification information includes at least one of an individual movement pattern of the person, a body size of the person and an outline of the person.

5. The circuitry of claim 1, wherein the recognizing of the person includes:
detecting a moving object based on the event-based visual data; and
identifying the detected moving object as a person based on at least one of an outline and a movement pattern.

6. The circuitry of claim 1, wherein at least one of the recognizing of the person and the tracking of the person is performed based on using an artificial neural network.

7. The circuitry of claim 1, wherein the circuitry is further configured to:
determine, based on a result of the tracking of the person, a region in which the person is not present; and
mark the region for allowing an automatic operation in the region.

8. The circuitry of claim 1, wherein the circuitry is further configured to:
determine, based on the event-based visual data, an object picked by the person.

9. The circuitry of claim 8, wherein the determining of the picked object is based on a shape of the object detected based on the event-based visual data.

10. The circuitry of claim 8, wherein the determining of the picked object is based on sensor fusion for detecting a removal of the object.

11. A method for event-based tracking, comprising:
recognizing a person based on event-based visual data from a first dynamic vision sensor camera and from a second dynamic vision sensor camera; and
tracking the person based on a movement of the person when the person leaves a first field-of-view of the first dynamic vision sensor camera and enters a second field-of-view of the second dynamic vision sensor camera.

12. The method of claim 11, wherein the tracking includes:
determining a motion vector of the person in the first field-of-view and a motion vector of the person in the second field-of-view based on positions of the first field-of-view and of the second field-of-view in a scene; and
tracking the person based on a movement indicated by the motion vectors.

13. The method of claim 11, wherein the tracking includes:
generating, based on the event-based visual data, identification information of the person;
detecting a collision of the person with another person based on the event-based visual data; and
re-identifying the person after the collision based on the identification information.

14. The method of claim 13, wherein the identification information includes at least one of an individual movement pattern of the person, a body size of the person and an outline of the person.

15. The method of claim 11, wherein the recognizing of the person includes:
detecting a moving object based on the event-based visual data; and
identifying the detected moving object as a person based on at least one of an outline and a movement pattern.

16. The method of claim 11, wherein at least one of the recognizing of the person and the tracking of the person is performed based on using an artificial neural network.

17. The method of claim 11, further comprising:
determining, based on a result of the tracking of the person, a region in which the person is not present; and
marking the region for allowing an automatic operation in the region.

18. The method of claim 11, further comprising:
determining, based on the event-based visual data, an object picked by the person.

19. The method of claim 18, wherein the determining of the picked object is based on a shape of the object detected based on the event-based visual data.

20. The method of claim 18, wherein the determining of the picked object is based on sensor fusion for detecting a removal of the object.
